(19) United States
(12) Patent Application Publication
(10) Pub. No.: US 2022/0183268 A1
(43) Pub. Date: Jun. 16, 2022

(54) DISPENSER

(71) Applicant: Angus CROSER, Penola (AU)

(72) Inventor: Angus CROSER, Penola (AU)

(21) Appl. No.: 17/598,621

(22) PCT Filed: Mar. 27, 2020
(86) PCT No.: PCT/AU2020/050297

§ 371 Date: Sep. 27, 2021

(30) Foreign Application Priority Data
Mar. 27, 2019 (AU) 2019901032

(51) Int. Cl. A01M 25/00

(52) U.S. Cl. CPC A01M 25/004

(57) ABSTRACT

A bait dispensing station including a cavity for holding a pellet of bait. The cavity can be enclosed preventing external access to the pellet. The statin also includes a compartment for holding a plurality of pellets and a means of dispensing a pellet into the cavity. A new pellet can only be dispensed into the cavity when no pellets are in the cavity. The cavity incudes a sensor to determine if there is a pallet in the cavity. The dispensing station includes a light sensor that controls access to the cavity and wherein access to the cavity is enabled essentially at night.

### FIELD OF THE INVENTION

The present invention relates to a dispenser that allows access to a dispensed item at only certain times. In particular the dispenser can be used to dispense bait.

### BACKGROUND TO THE INVENTION

Foxes are a very large problem in the farming community in Australia specifically in relation to lambs. Millions of lambs are taken by foxes every year, which simply typically eat the tongue and leave the rest of the carcass to rot, causing significant monetary damage to farmers.

There are controlled baits, such as 1080 which are effective at killing foxes in a 24 hour period. The problem with the bait is that it can also be taken by native animals or working dogs.

Because foxes are typically nocturnal animals, it is therefore desirable for bait to be accessibly only at night time and not during the day. It is an object of the present invention to provide such an apparatus or to provide the public with a useful alternative to those currently known.

### SUMMARY OF THE INVENTION

In a first aspect the invention comprises a bait dispensing station including a cavity for holding a pellet of bait, the cavity including a means to fully enclose it preventing external access to the pellet, a compartment for holding a plurality of pellets and a means of dispensing a pellet into the cavity.

In preference a new pellet can only be dispensed into the cavity when no pellets are in the cavity.

In preference the cavity incudes a sensor to determine if there is a pallet in the cavity.

In preference the sensor is a weight measuring sensor.

In preference the station includes a light sensor that controls access to the cavity and wherein access to the cavity is enabled essentially at night.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to the following drawings.

FIG. 1 is a conceptual sketch of a fox dispensing apparatus embodying the present invention.

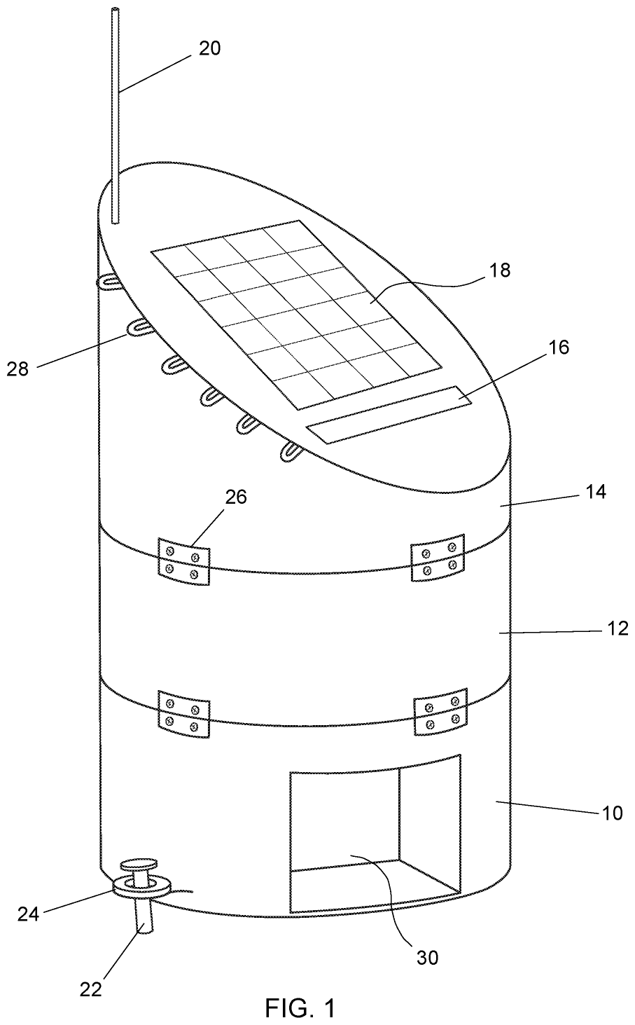

FIG. 2 is the apparatus illustrating disposed bait.

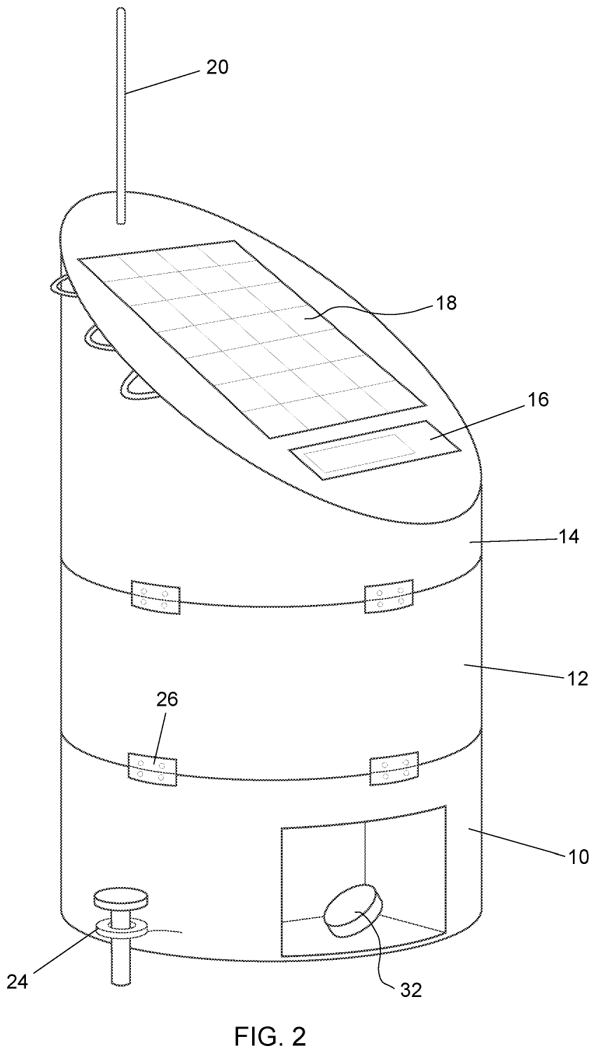

FIG. 3 is a side view of the apparatus.

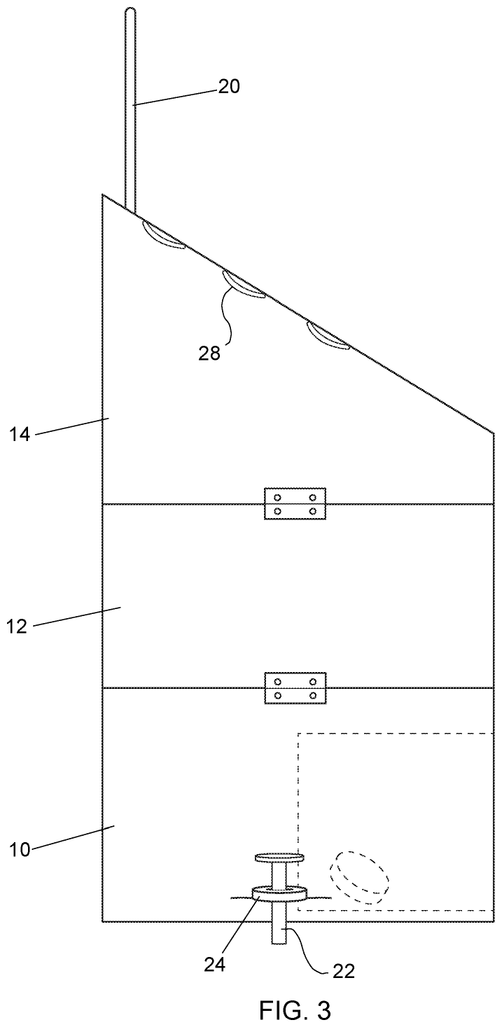

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

A completely conceptual drawing showing a fox dispensing apparatus according to the present invention is illustrated in the Figures. Thus, the apparatus includes three separate sections, a bottom section 10 which provides access to a 1080 pellet by a fox, second section 12 including a compartment that stores bait pellets, the pellets being dispensed by numerous potential means, including a spinning disk (not shown) that may dispense one pellet every 24 hours. It is to be understood that various other mechanisms may be employed to enable external access to the cavity.

The third section 14 includes a control panel 16, a solar panel 18 that recharges a battery in the dispenser to allow for its operation and antenna 20 that potentially allows for communication between the apparatus and an operator.

The control panel allows the user to program the dispenser as to the time when the cavity is accessible and when a new pellet is to be dispensed.

Pegs 22 can be used to secure the apparatus to the ground, there being extended feet 24 attached to the apparatus. Access to the hopper is via latches 26 and the top part of the apparatus may include protrusions 28 that allow branches or twigs to be attached to it to provide a bit of camouflage if it is wanted.

The basic idea therefore is that either at a predetermined time or based upon the ambient light, an electric panel (not shown) rotates to either enable access to a cavity 30 containing the pellet 32. Obviously, some circuitry will be required and a battery to allow the motor to operate and be recharged by the solar panel. Initially there may also be a weight sensing plate (not shown) at the bottom of the apparatus which can determine if a pellet is present or not and if a pellet is taken, the system proceeds to dispense another one, either immediately or after a certain time has passed.

Thus the system may include a light sensor that opens access to the cavity 30 when the light is low say at dusk and closes access to the cavity as dawn starts thereby preventing access to the bait during daylight hours thus protecting local fauna.

The person skilled in the art would realise there are many mechanical ways a bait can be dispensed and it is not intended to discuss any preferred arrangement.

With current communication techniques, the system may provide all of this information to a central database so that a farmer may have information of plurality of such dispensers and can monitor their effectiveness. They may also be provided various information as to how many baits are left in the apparatus, the time a bait was taken and if there are any faults with the apparatus.

The present invention thus provide a bait dispensing apparatus that enables bait to be accessed at pre-determined times, to reload the bait using a dispenser and potentially communicate that information using well known communication means.

### LIST OF COMPONENTS

The drawings include the following integers.
10 bottom section
12 middle section
14 third section
16 control panel
18 solar panel
20 antenna
22 pegs
24 feet
26 latches
28 protrusions
30 pellet (bait)

Any discussion of the prior art throughout the specification should in no way be considered as an admission that such prior art is widely known or forms part of the common general knowledge in this field.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and applications.

In the present specification and claims (if any), the word “comprising” and its derivatives including “comprises” and “comprise” include each of the stated integers but does not exclude the inclusion of one or more further integers.

1. A bait dispensing station including a cavity for holding a pellet of bait, the cavity including a means to fully enclose it preventing external access to the pellet, a compartment for holding a plurality of pellets and a means of dispensing a pellet into the cavity.

2. The dispensing station as in claim 1 wherein a new pellet can only be dispensed into the cavity when no pellets are in the cavity.

3. The dispensing station as in claim 1 wherein the cavity incudes a sensor to determine if there is a pallet in the cavity.

4. The dispensing station as in claim 3 wherein the sensor is a weight measuring sensor.

5. The dispensing station as in claim 1 including a light sensor that controls access to the cavity and wherein access to the cavity is enabled essentially at night.
